(19) United States
(12) Patent Application Publication
(10) Pub. No.: US 2024/0249857 A1
(43) Pub. Date: Jul. 25, 2024

(54) QUANTUM ILLUMINATION USING AN ION TRAP

(71) Applicant: The University of Sussex, Falmer (GB)

(72) Inventors: José Luis Verdú Galiana, Falmer (GB); Frances Crimin, Falmer (GB); Irene Marzoli, Falmer (GB)

(21) Appl. No.: 18/289,538

(22) PCT Filed: May 4, 2022
(86) PCT No.: PCT/GB2022/051135

§ 371 Date: Nov. 3, 2023

(30) Foreign Application Priority Data
May 4, 2021 (GB) 2106358.1

(51) Int. Cl. G21K 1/093

(52) U.S. Cl. CPC G21K 1/093

(57) ABSTRACT

A quantum illumination apparatus includes an ion trap in a cryogenic cooler. The ion trap uses electric and magnetic fields to trap an ion and the quantum illumination apparatus uses the trapped ion to produce a signal photon for use in quantum illumination. The signal photon has correlations with an idler field stored with use of the trapped ion, as a phonon of the trapped ion. A signal photon transmission line extends between the ion trap and an antenna. The signal photon may be scattered, e.g., reflected or refracted, by a target object back to the antenna, and the transmission line transmits the signal photon back to the ion trap. The ion trap generates an electrical signal based on correlations between the signal photon and the idler field. The quantum illumination apparatus is arranged to detect reception of the signal photon based on this generated electrical signal.

### FIELD OF THE DISCLOSURE

This disclosure relates to quantum illumination. The disclosure is particularly but not exclusively applicable to an apparatus for quantum illumination, and to an associated method, using an ion trap as a transducer for signal photons. Typically, the trapped ion is an electron and the signal photon is a microwave photon.

### BACKGROUND TO THE DISCLOSURE

Quantum illumination has been proposed as a method of detecting a target object in a noisy and lossy environment. The method generally involves the use of entangled photon pairs. When one photon of an entangled photon pair is scattered from a target object back to a receiver, it can theoretically be resolved from the background using its entangled twin stored at the receiver. Theory suggests that arrival of the photon can be detected with a very high degree of resolution. A target object may be detected using a very small number of entangled photon pairs, or even a single entangled photon pair, largely irrespective of the number of other photons present in the background. Quantum illumination has therefore received attention as a technology of huge potential, particularly in the fields of radar and microscopy.

Despite the potential of quantum illumination for use in object detection, obstacles remain in realising practical implementations of the technology. For example, in the paper “Microwave Quantum Illumination”, Shabir Barzanjeh et al, Physical Review Letters 114, 080053 (2015), the authors show that a quantum illumination detection signal can be generated with an error probability that is superior to that of classical radar at microwave wavelengths with equal transmitted energy. However, the method relies on electro-mechanical (EOM) converters for coupling photons between microwave and optical cavities, with the detection using optical wavelength photons. This is complex, but more problematically in order to avoid thermally induced noise within the EOM converters they are held at a temperature very close to absolute zero, specifically around 30 mK. This requires large and expensive cooling apparatus.

### SUMMARY OF THE DISCLOSURE

According to a first aspect of the disclosure, there is provided a quantum illumination apparatus comprising an ion trap. Similarly, according to a second aspect of the disclosure, there is provided a method of quantum illumination using an ion trap.

Optionally, the quantum illumination apparatus comprises a transmission line for conveying a signal photon to be directed to a target object and preferably wherein the ion trap is arranged to trap an ion selectively at either a first equilibrium position located a first distance from an input to the transmission line or at a second to equilibrium position located at a second distance from an input to the transmission line.

Optionally, the input to the transmission line is a cavity antenna.

Optionally, the quantum illumination apparatus comprises a source of electromagnetic radiation coupled to ion trap to provide photons of electromagnetic radiation generated by the source to the ion trap.

Optionally, the source of electromagnetic radiation is arranged to provide electromagnetic radiation having a wavelength in the range 1 mm to 100 m.

Optionally, the ion trap is arranged to trap an electron.

Optionally, the quantum illumination apparatus is arranged to generate an ion for trapping in the ion trap, preferably the quantum illumination apparatus comprises another source of electromagnetic radiation arranged to illuminate a target to release an ion for trapping in the ion trap, and more preferably the electromagnetic radiation is UV light and the ion is an electron.

Optionally, the signal photon used for quantum illumination has a wavelength in the range 1 mm to 100 m.

Optionally, the ion trap comprises a Penning trap, preferably a planar Penning trap.

Optionally, the ion trap has an array of magnetic elements arranged to generate a magnetic field to trap a/the ion in the ion trap, which magnetic field is a magnetic bottle.

Optionally, the ion trap has an array of electrodes arranged to generate an electric field to trap a/the ion in the ion trap, and a voltage source for controlling the electric potential applied to the array of electrodes such that a distance from the array of electrodes at which a/the ion trapped in the ion trap is held in the ion trap can be varied by varying the level of the electric potential applied to the array of electrodes by the voltage source.

Optionally, the quantum illumination apparatus comprises a resonator selectively couplable to a central electrode of an/the array of electrodes arranged to generate an/the electric field to trap an/the ion in the ion trap, the resonator being coupled to a signal detector for detecting electrical currents generated in the resonator by the trapped ion.

Optionally, the quantum illumination apparatus comprises a cryogenic cooler for maintaining the ion trap at a temperature of less than around 40K in use, and preferably less than around 4.2K.

Optionally, the method of quantum illumination comprises the steps of:
trapping an ion in the ion trap;
directing electromagnetic radiation to the trapped ion to generate vibrational modes of motion of the trapped ion in two different degrees of freedom of motion of the trapped ion, which generated vibrational modes of motion are coupled to one another by quantum entanglement;
coupling the vibrational mode of motion of just one of the two different degrees of freedom of motion of the trapped ion to transmission line so as to generated a signal photon;
maintaining the other of the two different degrees of freedom of motion of the trapped ion;
transmitting the signal photon to a target object;
receiving the signal photon from the target object;
coupling the received signal photon with the trapped electron; and
detecting changes in the frequency of the motion of the trapped electron in at least one of the vibrational modes of motion of the trapped electron in order to resolve reception of the signal photon from the background.

Optionally, coupling the vibrational mode of motion of just one of the two different degrees of freedom of motion of the trapped ion to transmission line comprises:
varying a voltage applied to at least one electrode of the ion trap to move the trapped ion closer to an input of the transmission line; and
controlling a switch to be in a conducting state such that a cavity in which the ion is trapped in the ion trap is electrically coupled to the input to the transmission line.

Optionally, detecting changes in the frequency of the motion of the trapped electron comprises detecting an AC voltage in a resonator coupled to at least one electrode of the ion trap.

Specific embodiments of the disclosure will now be described by way of example only, with reference to the accompanying drawings.

### BRIEF DESCRIPTION OF THE DRAWINGS

FIG. 1 is a schematic illustration of a quantum illumination apparatus according to a first preferred embodiment.

FIG. 2 is a schematic illustration of an ion trap of the quantum illumination apparatus.

FIG. 3 is a flowchart providing an overview of a method of quantum illumination using the quantum illumination apparatus of FIG. 1.

FIG. 4 is a generalised representation of the generation of entangled phonons in the ion trap.

FIG. 5 is a generalised representation of energy levels in an electron trapped in the ion trap.

FIG. 6 is a generalised representation of the generation of signal photons in the quantum illumination apparatus.

FIG. 7 is a generalised representation of operation of a resonator of the quantum illumination apparatus.

### DETAILED DESCRIPTION OF THE PREFERRED EMBODIMENTS

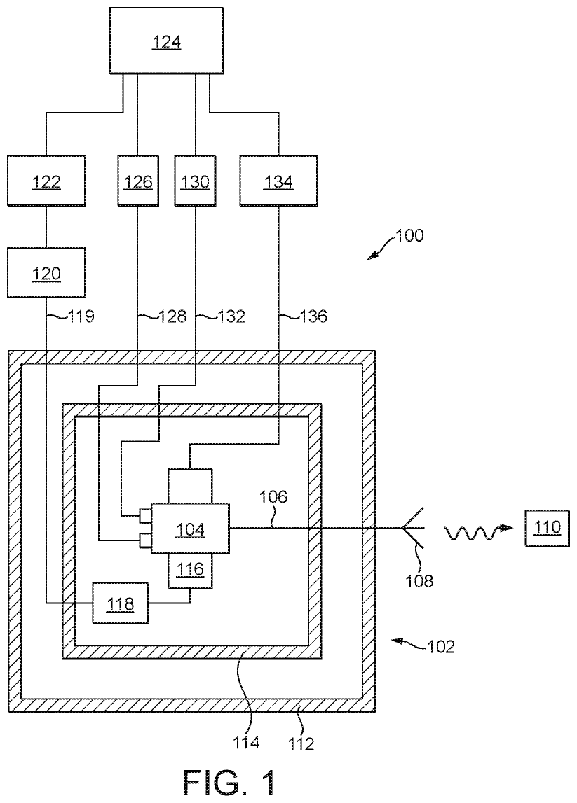

Referring to FIG. 1, a quantum illumination apparatus 100 comprises a cryogenic cooler 102. An ion trap 104 is provided within the cryogenic cooler 102. The ion trap 104 uses carefully controlled electrical and magnetic fields to trap an ion and the quantum illumination apparatus 100 is arranged to use the trapped ion to produce a signal photon for use in quantum illumination. The signal photon is associated with an idler field stored with use of the trapped ion, specifically a phonon of the trapped ion. In the described embodiment, the trapped ion is an electron and the signal photon is a Microwave (MW) photon, e.g. with a wavelength between about 1 mm and 1 m. In other examples the trapped ion may be a proton or an ion of an(other) atom and/or the signal photon may be a Radio Frequency (RF) photon.

The quantum illumination apparatus 100 has a signal photon transmission line 106 (or waveguide) extending between the ion trap 104 and an antenna 108. The signal photon transmission line 106 is arranged to transmit the signal photon to the antenna 108, and the antenna 108 is arranged to emit the signal photon. The signal photon may be scattered, e.g. reflected or refracted, by a target object 110 back to the antenna 108. The antenna 108 is arranged to receive the signal photon when it is scattered back to the antenna 108, and the signal photon transmission line 106 is arranged to transmit the signal photon back to the ion trap 104. The ion trap 104 is arranged to allow the returning signal photon to interact with the phonon of the trapped ion with which the signal photon is associated. Specifically, the ion trap 104 is arranged to generate an electrical signal based on quantum correlations between the signal photon and the phonon. The quantum illumination apparatus 100 is arranged to detect reception of the signal photon based on this generated electrical signal.

In more detail, in the illustrated embodiment the cryogenic cooler 102 is a closed-cycle cryo-cooler, e.g. a Pulse-Tube Cryo-cooler, capable of cooling the ion trap 104 to around 4.2K. As can be seen from FIG. 1, the cryogenic cooler 102 comprises a first cooling stage 112. There is also a second cooling stage 114 within the first cooling stage 112. The ion trap 104 is located within the second cooling stage 114. Typically, the temperature within the first cooling stage 112 is around 60K and the temperature within the second cooling stage 114 is around 4.2K. In other embodiments, the cryogenic cooler 102 may be any other suitable type of cooling system, including single stage coolers. In one specific alternative embodiment, the cryogenic cooler 102 is a Stirling cooler. In some such alternative embodiments, the ion trap 104 may be cooled to a higher temperature of around 40K.

In the prior art temperatures as low as 30 mK are required. The higher temperatures of the described embodiments provide considerable advantages over this. For example, where the temperature of the ion trap is around 4.2K, this is similar to the temperature of liquid Helium (He), meaning that the cryogenic cooler 102 can incorporate circulation of liquid He as a cooling mechanism and the cooling can be achieved with less complexity and more cheaply than in the prior art. In the embodiments of that use the higher temperature of 40K, the quantum illumination apparatus 100 can be realised at bench-top sizes and with commensurately low electrical power requirements and cost.

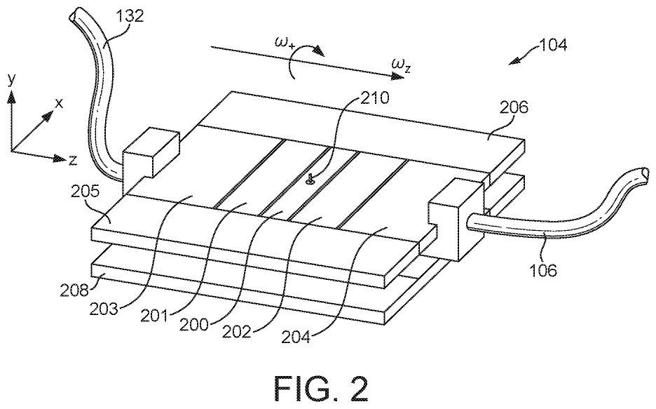

The ion trap 104 is similar to that described in International patent publication no. WO2013/041615. Specifically, the ion trap 104 may be a Penning trap, and more specifically a Co-planar Waveguide Penning (CPW) trap. Referring to FIG. 2, the ion trap 104 has a magnetic element array 208 for generating a static magnetic field and an electrode array for generating an electric field. The magnetic elements of the magnetic element array 208 may be superconducting. Suitable superconducting materials include, but are not limited to, Niobium Titanium (NbTi), Magnesium Diboride (MgB2), Yttrium Barium Copper Oxide (YBCO), Gadolinium Barium Copper Oxide (GdBCO). In the embodiment in which the temperature of the ion trap 104 is held at around 4.2 K, the preferred superconducting material is NbTi.

The magnetic element array 208 and the electrode array are enclosed within a cavity (not shown). The cavity defines a volume in which the ion is trapped. The cavity comprises, or is located within, a vacuum chamber (not shown) that can maintain an Ultra High Vacuum (UHV), typically of less than 10⁻⁷ mbar. The ion trap 104 also has an ion source. In the illustrated embodiment, the ion source comprises a target, which, when illuminated with UV photons from a UV source 126, releases electrons under the photoelectric effect. Typically, the electrons released from the target have kinetic energy that is a little too high to allow them to be easily caught in the ion trap 104 themselves. Rather, the released electrons, referred to as primary electrons, interact with atoms present in the cavity of the ion trap 104 to release further electrons from these atoms (and also create positively charged ions). These further electrons, referred to as secondary electrons, tend to have lower kinetic energy than the primary electrons and it is generally these secondary electrons that are caught in the ion trap 104 and used as the trapped electron. It should be noted that whilst this is the scenario implemented in the illustrated embodiment, the skilled person will understand that other arrangements are possible in which the primary electrons can be successfully trapped.

In the illustrated embodiment, the target is typically a metal, such as gold, silver or copper. As well as these metals being susceptible to releasing electrons by the photoelectric effect under UV light, it is useful for the target to be conducting so that electrical charge generated by the release of the electrons into the trap can be drawn away to ground. In some embodiments, the target is simply a part of the wall of the cavity.

In another embodiment, the ion(s) or electron(s) is/are provided using an electron gun located outside of the ion trap 104. The electron gun is arranged to direct a beam of electrons at the target located within the ion trap 104. The electrons of the electron beam release further electrons from the target, and again these electrons may in turn interact with atoms in the cavity of the ion trap 104 to release secondary electrons with appropriate energy for being trapped in the ion trap 104. In this embodiment, the target may be graphite instead of a metal.

In the illustrated embodiment, the magnetic element array 208 and the electrode array are substantially flat. Specifically, the magnetic element array 208 and the electrode array are each planar, lying in adjacent parallel planes. However, it is not the precise geometry of the magnetic element array 208 and the electrode array that is important, but the shape and interrelationship of the of the magnetic and electric fields they generate. In this regard, the electrode array defines a surface facing a volume within the cavity in which the magnetic field generated by the magnetic element array 208 is substantially homogeneous above the middle of the electrode array, or a so-called magnetic bottle. The electrode array is arranged such that, when appropriate voltages are applied to it by a voltage source 134, the electrode array generates an electric field that, in conjunction with the magnetic field, can trap an ion in the volume.

In the illustrated embodiment, the electrode array comprises a primary electrode 200 (also referred to as the ring electrode), two secondary electrodes 201, 202 (also referred to as the correction electrodes) and two tertiary electrodes 203, 204 (also referred to as the endcap electrodes). The primary electrode 200, secondary electrodes 201, 202 and tertiary electrodes 203, 204 are arranged in a row. The primary electrode 200 is provided centrally. The two secondary electrodes 201, 202 are arranged adjacent to the primary electrode 200, with one to each side of the primary electrode 200. The two tertiary electrodes 203, 204 are arranged adjacent to the secondary electrodes 201, 202 on opposite sides of the secondary electrodes 201, 202 to the primary electrode 200 (or at the ends of the row). The primary electrode 200 has the shortest length along the length of the row, and the tertiary electrodes 203, 204 each have the longest length along the length of the row. The dimensions and spacing of the primary electrode 200, two secondary electrodes 201, 202 and two tertiary electrodes 203, 204 have mirror symmetry along the length of the row, about the midpoint of the primary electrode 200. Side electrodes 205, 206 are also provided, one to each side of the row, generally extending all the way along the length of the row. The primary electrode 200, secondary electrodes 201, 202, tertiary electrodes 203, 204 and side electrodes 205, 206 are typically a metal, such as Gold, Silver or Copper. They are provided on a substrate that is an insulator, e.g. Silicon Dioxide (SiO₂), but in the illustrated embodiment Sapphire (Al₂O₃).

In some embodiments, more than one ion trap 104 may be provided in the same quantum illumination apparatus 100. This can be achieved in a variety of ways, with the different ion traps sharing different components accordingly. In one particular embodiment, the electrode array can be replicated elsewhere on the substrate, associated with a replicated magnetic element array, to provide an additional ion trap. Several such additional ion traps may be provided in this way, each being substantially the same as or similar to one another. These additional ion traps may share the same cavity as the ion trap 104 described in the main embodiment, with the various transmission lines and other componentry replicated or shared as appropriate. Hence, the quantum illumination apparatus 100 can have many independent or interlinked ion traps, each with one trapped electron (or other ion). In effect, many discrete quantum illumination procedures can be implemented alongside one another using these different ion traps.

A resonator 116 is coupled to the ion trap 104. The resonator 116 comprises one or more conducting paths coupled to the secondary electrodes 201, 202 of the ion trap 104 such that currents may be induced in the resonator 116 by movement of the trapped electron, particularly in the axial mode. The resonator 116 may be referred to a resonator circuit or LC resonator. It has an inherent inductance and capacitance, which may be tuned to the frequencies of the electrical signals it is intended to detect.

In the illustrated embodiment, the resonator 116 has two conducting paths, a first conducting path from one of the secondary electrodes 201 to ground and a second conducting path from the other of the secondary electrodes 202 to ground. In other embodiments the resonator 116 may comprise a conducting path between the two secondary electrodes 201, 202 or coupled to the primary electrode 200. The resonator 116 may comprise any conducting material, e.g. a metal such as copper, but in the illustrated embodiment it comprises a superconductor. The superconductor may be NbTi, MgB₂. YBCO, GdBCO or another suitable superconductor, as explained above in relation to the magnetic elements.

The resonator 116 is arranged such that vibration of the trapped electron in a direction parallel to the row of electrodes, e.g. axial motion of the trapped electron, generates an electric current in the resonator 116. The electric current is typically an Alternating Current (AC) with a frequency dependent upon the frequency ω_{z} of the axial motion of the trapped electron. The frequency of the AC is typically in the range of 1 MHZ to 1000 MHZ, or more typically 1 MHz to 100 MHz. The resonator 116 is electrically coupled to an input of a cryogenic amplifier 118; an output of the cryogenic amplifier 118 is electrically coupled to an input of a room temperature amplifier 120; and an output of the room temperature amplifier 120 is electrically coupled to an input of a signal analyser 122.

The cryogenic amplifier 118 is a transistor located within the cryogenic cooler 102; more specifically (in the illustrated embodiment at least) within the second cooling stage 114 of the cryogenic cooler 102. The room temperature amplifier 120 is located outside of the cryogenic cooler 102. The cryogenic amplifier 118 is electrically coupled to the room temperature amplifier 120 via a coaxial cable 119 that passes from within the cryogenic cooler 102, specifically from within the second cooling stage 114, to outside of the cryogenic cooler 102. In this embodiment, the cryogenic amplifier 118 is a Field Effect Transistor (FET), specifically a Gallium Arsenide (GaAs) Pseudomorphic High Electron Mobility (PHEM) transistor. The cryogenic amplifier 118 is arranged to receive the AC voltage generated in the resonator 116 at its input and to amplify the voltage in order to provide a cryogenically amplified detection signal at its output. The room temperature amplifier 120 is arranged to receive this cryogenically amplified detection signal at its input via the coaxial cable 119 and to amplify the cryogenically amplified detection signal further in order to provide a room temperature amplified detection signal at its output. In this embodiment, the room temperature amplifier 120 is an operational amplifier.

The signal analyser 122 is arranged to receive the room temperature amplified detection signal from the room temperature amplifier 120 at its input. In this embodiment, the signal analyser 122 is a spectrum analyser, in this example a Fast Fourier Transform (FFT) spectrum analyser. The signal analyser 122 allows the room temperature amplified detection signal to be observed in the frequency domain. Features of this observation may be provided to a controller 124 of the quantum illumination apparatus 100.

The quantum illumination apparatus 100 has a Microwave (MW) source 130 coupled to the ion trap 104 via a MW transmission line 132. The MW source 130 is arranged to generate MW photons under the control of the controller 124, and the MW transmission line 132 is arranged to transmit the MW photons to the ion trap 104. Some of these MW photons interact with the trapped electron in such a way as to transfer energy to the trapped electron in the form of vibrational modes of motion of the trapped electron, or phonons. These phonons can be used to generate the signal photon and to facilitate interaction of the returning signal photon with the trapped electron during detection, as discussed in more detail below.

The quantum illumination apparatus 100 also has a voltage source 134 for applying voltages to the electrode array of the ion trap 104. In this embodiment, the voltage source 134 comprises several voltage calibrators, e.g. one each of the primary, secondary, tertiary and side electrodes 200, 201, 202, 203, 204, 205 of the ion trap 104. The voltage source 134 is electrically coupled to the primary, secondary, tertiary and side electrodes 200, 201, 202, 203, 204, 205 of the ion trap 104 via an electrical supply line 136. For example, voltage calibrators are coupled to each of the primary, secondary, tertiary and side electrodes 200, 201, 202, 203, 204, 205. The controller 124 controls the voltage source 134 to apply voltages to the electrode array in such a way that an electron generated by the ion source, specifically one of the secondary electrons described above, is held within the ion trap 104 by its interaction with the electric field generated by the electrode array and the magnetic field generated by the magnetic element array 208.

In order to help the cryogenic cooler 102 to maintain the required temperatures within the first cooling stage 112 and second cooling stage 114, the coaxial cable 119, optical fibre 128, MW transmission line 132 and electrical supply line 136 are provided with couplers (not shown) at the locations they pass into the first cooling stage 112 and into second cooling stage 114. The couplers improve thermal isolation of the first and second cooling stages 112, 114 and hence reduce the cooling power required to maintain the low temperatures within the first and second cooling stages 112, 114. The couplers inevitably cause a degree of attenuation along the coaxial cable 119, optical fibre 128, MW transmission line 132 and electrical supply line 136, but this is perfectly tolerable. In contrast, signal loss in the signal photon transmission line 106 between the ion trap 104 and the antenna 108, through which the signal photon is conveyed, is less tolerable. Therefore, coupling this signal photon transmission line 106 where is passes into the first and second cooling stages 112, 114 requires more careful consideration, to minimise attenuation. In the present embodiment, couplers for the signal photon transmission line 106 comprise matched horn antennas and Teflon windows, e.g. as described in the paper “Observing the Quantum Limit of an Electron Cyclotron: QND Measurements of Quantum Jumps between Fock States”, S. Peil and G. Gabrielse, Physical Review Letters, 83:1287-1290, 1999. Usefully, the couplers of the signal photon transmission line 106 may also be directional, so as to reduce reflections within the signal photon transmission line 106 that may interfere with propagation of the signal photons in the signal photon transmission line 106 in undesirable ways. Attenuation can also be reduced by using signal photons towards the lower end of the possible frequency range supported by the ion trap 104, e.g. below 1 GHz rather than up to around 150 GHz.

As mentioned above, the signal photon transmission line 106 extends between the ion trap 104 and an antenna 108. In order to facilitate generation of signal photons in the signal photon transmission line 106, the signal photon transmission line is coupled to the cavity of the ion trap 104. This may be achieved by electrically coupling an input of the signal photon transmission line 106 to one of the electrodes of the electrode array, typically the primary electrode 200. However, in the illustrated embodiment, the ion trap 210 has a cavity antenna 210 electrically couplable to the signal photon transmission line 106 via a switch (not shown). The cavity antenna 210 is a small needle located in the middle of the primary electrode 200, electrically isolated from the primary electrode 200. The needle extends normal to the plane of the electrode array into the volume defined by the cavity of the ion trap 104. With the switch closed, that is in a conducting state, the cavity antenna 210 is electrically coupled to an input of the signal photon transmission line 106, such that signal photons can be generated in the signal photon transmission line for transmission to the antenna 108 and emission in the direction of the target object 110, as described in more detail below.

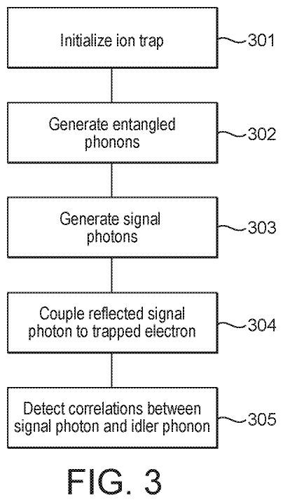

Referring to FIG. 3, a method of quantum illumination using the quantum illumination apparatus 100 involves, at step 301, initialising the ion trap 104. Specifically, the cryogenic cooler 102 reduces the temperature within the first cooling stage 112 to around 60K and within the second cooling stage 114 to around 4.2K. With the ion trap 104 within the second cooling stage 114 at the steady temperature of around 4.2K, the controller 124 controls the voltage source 134 to apply voltages to the electrode array such that a potential well is provided above the primary electrode 200. The ion source is then used to generate an electron for trapping in the ion trap 104. Specifically, the UV source 126 is used to inject UV photons into the ion trap 104 via the optical waveguide 128, the UV photons interact with the target to release electrons from the target and these electrons in turn interact with atoms in the cavity of the ion trap 104 to produce secondary electrons that are trapped by the ion trap 104. In order to trap the electrons, they are urged by the magnetic and electric fields of the ion trap 104 to a location within the ion trap 104 approximately at the centre of the electrical potential well, or at the so-called equilibrium position. At this location, a trapped electron undergoes a motion that has three components, a cyclotron motion, an axial motion, and a magnetron motion.

Each of the cyclotron motion, axial motion, and magnetron motion are harmonic oscillations. In the present embodiment (with the trapped ion being an electron), the magnetron motion typically has a frequency ω₋ in a range of 1 kHz to 100 kHz, the cyclotron motion typically has a frequency ω₊ in a range of 1 GHz to 200 GHz and the axial motion typically has a frequency ω_{z} in the range 1 MHz to 100 MHz. In other embodiments (e.g. in which the trapped ion is not an electron), the magnetron motion may have a frequency ω₋ in a range of 1 kHz to 100 kHz, the cyclotron motion may have a frequency ω₊ in a range of 0.1 MHz to 100 MHz and the axial motion may have a frequency ω_{z} in the range 100 KHz to 1 MHz. So, the frequency ω₋ of the magnetron motion is generally much smaller than the frequencies ω₊, ω_{z} of the cyclotron motion and the axial motion. The magnetron motion is also decoupled from, e.g. effectively independent of, the cyclotron motion and the axial motion. For the purposes of the present method, the magnetron motion can therefore be ignored and just the cyclotron motion and the axial motion considered further. It will be seen that only the cyclotron motion and the axial motion are represented by respective arrows in FIG. 2. It should also be mentioned that the trapped electron has intrinsic spin, which can have values of ±½.

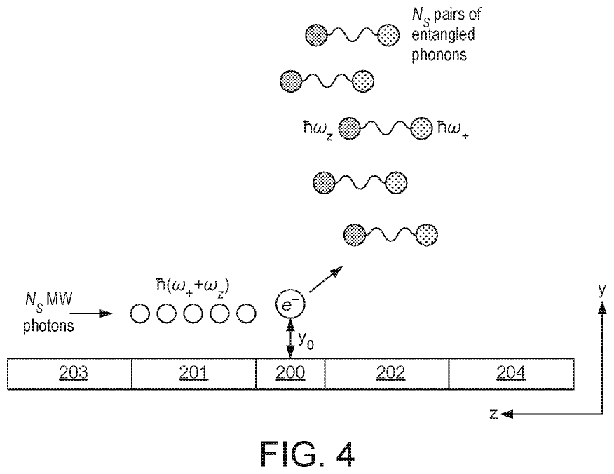

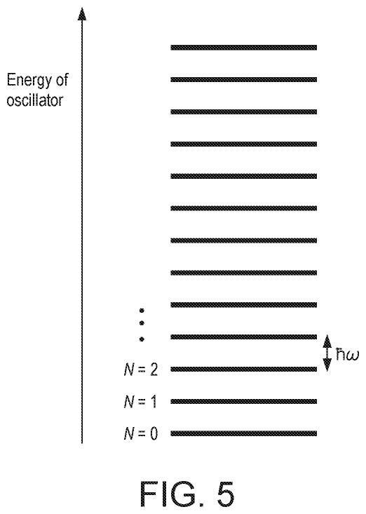

With at least one ion (in the present embodiment an electron) trapped in the ion trap 104, the next stage is to generate entanglement between phonons of the cyclotron motion and the axial motion of the trapped electron, at step 302. In order to achieve this, the controller 124 controls the MW source 130 to apply MW photons to the ion trap 104 via the MW transmission line 132. The interaction between the MW photons and the trapped electron is shown conceptually in FIG. 4, from which it can be seen that the MW photons have energy E= [symbol] (ω₊+ω_{z}), where [symbol] is Planck's constant. When one such MW photon interacts with the trapped electron, it may be absorbed and its energy transferred to the electron. The energy of the MW photon generates two phonons associated with the trapped electron, these phonons each being associated with one of the modes of vibration of the electron and (in the cyclotron and axial modes) having energy E₊= [symbol] ω₊ and E_{z}= [symbol] ω_{z} respectively. It should be noted that each mode of vibration of the electron has a discrete energy spectrum with equally spaced energy levels, as represented in FIG. 5.

The lowest energy level has a Quantum number N equal to 0, the first energy level has a Quantum number N equal to 1, the second energy level has a Quantum number N equal to 2 and so on.

As the MW photons pass into the ion trap 104, a number N_{S} of them interact with the trapped electron to generate N_{S} pairs of entangled phonons. These new entangled phonons are stored in their respective motions and their entanglement means that the cyclotron and axial degrees of freedom, which were once completely independent, can now only be described as a whole, non-separable quantum state. The electric field component of the MW photons is coupled to the electrodes of the ion trap 104 at the position of the trapped electron. Looking at this mathematically, the electrical field component can be considered to have the shape \vec{E}_{MW}=∈_{Q} cos((ω_{z}+ω₊)t)·(z, 0, x), where ∈_{Q} is the amplitude of the microwave's electric field, proportional to the number of the MW photons, t represents time, z represents the axial position of the trapped electron, and x represents the horizontal position of the trapped electron transverse to the axial direction. In an alternative analysis, the electrical field component can be considered to have the shape \vec{E}_{MW}=∈_{Q} cos((ω_{z}+ω₊)t)·(0, z, y), where ∈_{Q} is again the amplitude of the microwave's electric field, t represents time, z represents the axial position of the trapped electron, and y represents the vertical position of the trapped electron transverse to the axial direction or normal to the electrode array. Taking just the former analysis in this instance, the quantisation of the motional degrees of freedom z, y of the trapped electron results in the interaction Hamiltonian between the trapped electron and the MW photon in the Dirac interaction picture of H_{I}=i [symbol] Ω_{I}(a_{z}a₊−a_{z}⁺a₊⁺), where i=\sqrt{−1}Ω_{I}∝∈_{Q}, a_{z}⁺ is the creation operator of the axial motion of the trapped electron, at is the creation operator of the cyclotron motion of the trapped electron, a_{z} is the annihilation operator of the axial motion of the trapped electron, and a₊ is the annihilation operator of the cyclotron motion of the trapped electron. The application of the classical MW to one or more of the electrodes of the ion trap 104, such that said MW electric field component has the mathematical dependence \vec{E}_{MW}=∈_{Q} cos((ω_{z}+ω₊)t)·(z, 0, x) results in the so-called “two-mode squeezing” operation. Here, “two-mode” refers to the axial and cyclotron motional degrees of freedom of the trapped electron. It is the application of this MW electric field component with this mathematical shape that generates the entanglement, also known as quantum correlations, between the signal and the idler phonons of the trapped electron. In another embodiment, signal-idler entanglement could be implemented with cyclotron-magnetron, or axial-magnetron two-mode squeezing. Two-mode squeezing is the quantum mechanical process which underlies in “spontaneous parametric down conversion,” a technique commonly used for generating entangled photons in the visible domain. Whilst two-mode squeezing is the preferred technique, it is also possible to exploit entanglement in other ways, such as by four-wave mixing or by other quantum operations generating quantum correlations between the two vibrational modes of the trapped ion.

The number N_{S} of input MW photons and entangled phonon pairs is determined by the strength ∈_{Q} and the duration of the applied MW field:

$${N}_{S} = number of entagled pairs ≡ {N}_{S} ( {ϵ}_{Q} , t ) \qquad ( 1 )$$

In contrast to other technologies, the present method can achieve large numbers of entangled phonon pairs, e.g. 10,000 or more, using only very short pulses of the MW field, e.g. of between 1 and 1000 ms. A high number of entangled phonon pairs is desirable so that a correspondingly high number of signal photons can be generated. A larger number of signal photons should provide a larger signal, as there is a greater chance of a signal photon being returned from the target object 110.

In more detail, the strength [symbol] of the correlations that arise between the cyclotron and axial modes as a result of this entanglement field is defined by:

$$C = strength of quantum correlation ≡ C ( {ϵ}_{Q} , t ) \qquad ( 2 )$$

This strength [symbol] is maximised by increasing the number N_{S} of entangled phonon pairs.

It is also possible to define G₀, the energy gain of the system achieved by the entangling field, as

$${G}_{0} = {cosh}^{2} ( {ϵ}_{Q} t ) \qquad ( 3 )$$

where ∈_{Q} is the renormalized MW field strength. The relationship between the number N_{S} of entangled phonon pairs and the strength [symbol] of the correlations is given by

$$\frac{{N}_{S}}{C} = \sqrt{\frac{{G}_{0} - 1}{{G}_{0}}} \qquad ( 4 )$$

Having established entanglement between the phonons of the cyclotron and axial motion of the trapped electron, the next step is to use the cyclotron motion of the trapped electron to produce the signal photons in the signal photon transmission line 106. This is achieved by positioning the trapped electron close to the cavity antenna 210 and closing the switch of the cavity antenna 210 such that the cavity antenna 210 is electrically coupled to the transmission line 106. In this state, phonons of the cyclotron motion of the trapped electron can generate the signal photons in the signal photon transmission line 106 by the electric dipole interaction of the cyclotron degree of freedom of the trapped electron with the allowed MW propagation modes of said transmission line 106. The principles on which this is based have been discussed in detail in “Single Microwave Photon Detection with a Trapped Electron”, A. Cridland et al, Photonics 3, 59-73 (2016). On the other hand, phonons of the axial motion of the trapped electron do not interact with the signal photon transmission line 106, as this motion only creates an electric dipole parallel with the signal photon transmission line 106. This inhibition of the interaction of the axial motion and a primary electrode of an ion trap has been discussed in detail in “Electronic Detection of a Single Particle in a Coplanar-waveguide Penning Trap”, A. Al-Rjoub et al, Applied Physics B 107, 955 (2012).

In more detail, the cyclotron motion of the electron is in the radial plane of the ion trap 104, or transverse to the signal photon transmission line 106 where it passes underneath the ion trap 104. Signal photons in the signal photon transmission line 106 can be considered to have an electrical component \vec{E} with directional constituents Eₓ and E_{y}, each transverse to direction in which the signal photons propagate in the signal photon transmission line 106. The motion of the trapped electron can be considered to create a moving electrical dipole \vec{P} with directional constituents \vec{P}=q(X, Y, Z). The interaction between the motion of the electron and the signal photons is then \vec{E}·\vec{P}. The coupling will occur through the cavity antenna 210 of the ion trap 104. At the position of the antenna 210, due to symmetry there is no component of the electron dipole moment in the axial direction. Thus, even accounting for stray components of the signal photon transmission line 106, these fields will not interact with the axial degree of freedom. In this way, the axial mode does not “see” the signal photon transmission line 106 opened by the switch of the cavity antenna 210, and phonons of this mode remain as our idler field in the trap.

In order to control coupling of the motion of the trapped electron to the signal photon transmission line 106, it is important to have a switchable coupling arrangement. This allows entanglement of the phonons of the cyclotron and axial motion of the trapped electron to be established before creation of the signal photons, and for subsequent return of the signal photons from the target object 110 to be detected. In addition, it is important that the axial motion of the trapped electron, which acts as the idler field, remains stored whilst the signal photon, which is coupled to the cyclotron motion alone, travels to and from the target object 110.

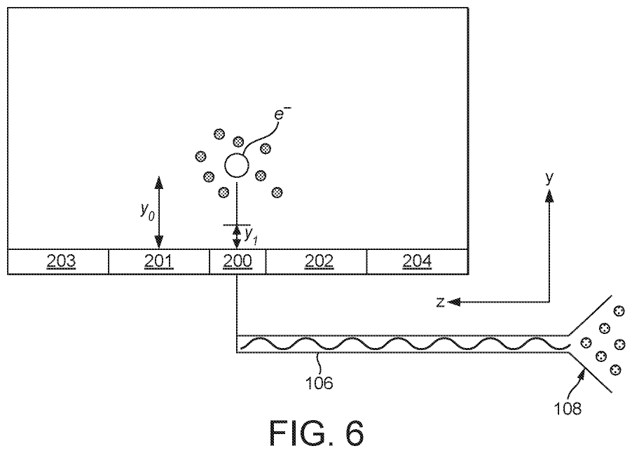

Referring to FIG. 6, the ion trap 104 allows the height of the trapped electron above the electrode array to be altered. This is enabled by the planar design of the ion trap 104, and is achieved by adjusting the voltages applied to the electrode array. Varying the voltages applied to the electrode array by the voltage source 134 changes the profile of the electric field, and thus the equilibrium trapping position. As this equilibrium position is altered, the trapped electron will follow the equipotential lines to arrive at a new position above the surface of the electrode array.

During step 302, when the entanglement of the phonons of the cyclotron and axial motion of the trapped electron is being established, the height of the trapped electron is controlled to be at a first trapping height y₀. At subsequent step 303, during which the signal photons are generated in the signal photon transmission line 106, the height of the trapped electron is controlled to be at a second trapping height y₁. The second trapping height y₁ is lower than the first trapping height y₀. Because the cavity antenna 210 is located on the primary electrode 200, the trapped electron is closer to the cavity antenna 210 when it is at the second trapping height y₁, and the phonons of the cyclotron mode can interact with the signal photon transmission line 106. On the other hand, when the trapped electron is at the first trapping height y₀, it is further from cavity antenna 210, at least sufficiently so that the phonons of the cyclotron mode do not interact with the signal photon transmission line during step 301. It will be recognised that coupling and decoupling the trapped electron with the signal photon transmission line 106 can be achieved in other ways. For example, the cavity antenna 210 could be located at a different location, such as above or to one side of the electrode array, and the electric or magnetic field altered in a different way to move the equilibrium trapping position of the electron closer to and further from the signal photon waveguide. Alternatively, the cavity antenna 210 itself could be physically moveable.

It is important that the transfer of energy from the cyclotron motion of the trapped electron to the signal photons in the signal photon transmission line 106 is as coherent as possible. The considerations for this are somewhat similar to studies of cavity Quantum ElectroDynamics (QED) experiments, see, e.g., the paper “High-Fidelity Trapped-Ion Quantum Logic Using Near-Field Microwaves”, T P Harty et al., Physical Review Letters, 117, 140501 (2016). For the purposes of considering the present method, we assume that

$${r}_{transfer} ≫ {r}_{decoherence} \qquad ( 5 )$$

That is, the entanglement will be successfully transferred from the phonons of the cyclotron motion of the trapped electron to the signal photons in the signal photon transmission line 106 if the rate of transfer to the signal photon transmission line, r_{transfer}, is much larger than the decoherence rate, r_{decoherence}, of this exchange. In essence, it can be assumed that all correlations are transferred from the phonons to the propagating signal photons. As such, the signal photons are generated in the signal photon transmission line 106 without any loss of coherence.

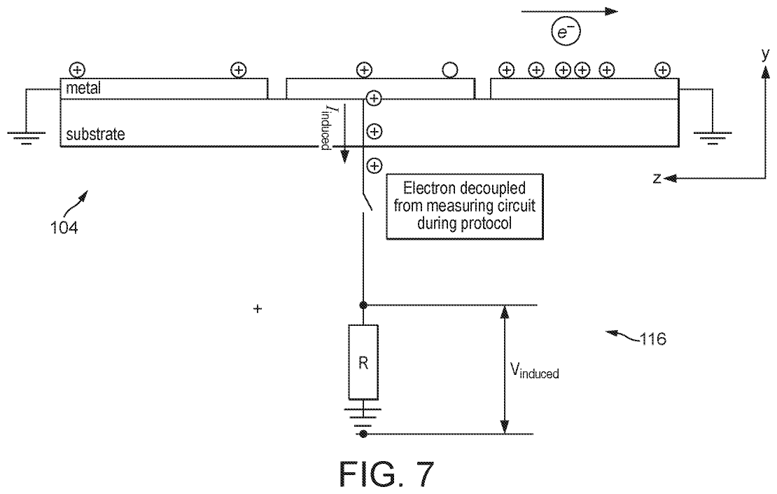

As mentioned above, the signal photons propagate along the signal photon transmission line 106 to the antenna 108, from which they are emitted, and in the event that a signal photon is scattered or reflected back from the target object 110 to the antenna 108, the signal photon propagates back along the signal photon transmission line 106 to the ion trap 104 along with numerous other photons from the thermal background environment. During this time, the electron remains trapped in the ion trap 104 and the phonons of the axial motion of the electron, which are entangled with the phonons of the cyclotron motion that were used to generate the signal photon, remain undisturbed, e.g. are stored as the so-called idler field. Importantly, referring to FIG. 7, the resonator 116 incorporates a switch 700 between the central electrode 200 and the resonator circuit, and this switch 700 is in a non-conducting state during the time that the idler field is being stored in the ion trap 104 in order to prevent any induced currents causing attenuation of the idler field.

When a signal photon returns to the ion trap 104, it is recombined, at step 304, with the idler field to generate correlations that may be detected. The method involves collecting a sample of MW photons with the correct frequency, which may or may not contain a signal photon. The background photons can be modelled in a consistent and realistic way by treating them as in a thermal bath at temperature T. Low reflectivity of the target object 100 propagation losses of the signal photons can be accounted for using a single reflectivity parameter, κ, which is bounded by 0<κ<<1. Then, representing the total number of signal photons which return to the trap by κN₊, so that setting κ=0 means that the target object 110 is absent, a value for K representing a realistic return of the signal photons might be for instance around 10⁻¹⁰ or orders of magnitude lower. Meanwhile, the total number of noise photons collected in a single measurement, represented by N_{B}, may be determined through the Planck black-body distribution spectrum, by the temperature of the environment and the MW frequency of interest.

If we assume that the target object 110 is travelling at high speed, e.g. Mach 1, and that the MW photons have a frequency of 10 GHZ, then the Doppler shift of the signal photons between their outward propagation and their return is 22 kHz. In order to account for this, the ion trap 104 incorporates a magnetic bottle, e.g. as described in the paper “Geonium theory: Physics of a single electron or ion in a Penning trap”, Lowell S. Brown and Gerald Gabrielse. Reviews of Modern Physics, 58, 233 (1986). In essence, the magnetic bottle comprises a symmetric gradient in the magnetic field that still facilities trapping the electron but broadens the range of frequencies of the resonance of the cyclotron motion of the electron held in the ion trap 104. Typically, the magnetic bottle reduces the quality factor of the ion trap 104 to around 10⁶, but any Doppler-shifted return signal photons still find correlations with the phonons of the electron in the ion trap 104. The axial phonons remain unaffected, and still act as an idler filed, so that they can be stored for long times while the signal photons interrogate the target object 110. Indeed, a coherence time of the stored axial mode of only around 1 ms enables the signal photons to be sent a distance of 300 km. This conservative estimate is approximately ×30 greater than achievable distances predicted by other proposed quantum illumination technologies. It must be observed also that the quantum illumination advantage is still available even if the original entanglement of all of the signal-idler phonons does not survive.

It will be appreciated that both the signal and noise photons are converted to phonons provided they are in a frequency range that resonates with the trapped electron. In other words, the entangled axial phonons are recombined with cyclotron phonons generated from photons in the signal photon transmission line 106 both originating from the background field and that are returned signal photons. To reveal whether any signal photons have been returned from the target object 110, joint measurement of this recombination identifies a signature of the original correlations.

The recombination of the vibrational modes of the ion trap 104 can be achieved by the application of a second MW field, \vec{E}′, to the ion trap 104, e.g. by again generating MW photons at the MW source 130 and transmitting them to the ion trap 104 via the MW transmission line 128. This MW field has the same form as that applied in order to generate the entangled cyclotron and axial phonons, \vec{E}′=∈′_{Q}(z, x, 0)cos((ω₊+ω_{z})t), and again oscillates at the frequency ω₊+ω_{z}. Application of this MW field is mathematically equivalent to recombining phonons stored in the ion trap 104 in an Optical Parametric Amplifier (OPA) with gain G. This Gain G depends on the strength and duration of application of the MW field. The OPA is the quantum receiver of the quantum illumination apparatus 100, for implementing the Gaussian quantum illumination protocol.

As discussed, in the illustrated embodiment, the detection is based on the quantum number N₊ of the cyclotron motion of the electron, using the “continuous Stern-Gerlach effect” given by equation (6) below. However, it is possible to use either the quantum number N₊ of the cyclotron motion or the quantum number N_{z} of the axial motion of the electron in the ion trap 104, and the analysis below looks at both. It is also possible to reverse the roles of signal-idler, that is: using the axial motion phonons as the source for the signal photons, while the cyclotron phonons are used as the idler mode. This has the critical advantage of extending the application of the quantum illumination protocol to the RF domain, which is inaccessible in other implementations of the Gaussian quantum illumination protocol.

In practical terms, the detection is based on the frequency ω_{z} of the axial motion of the trapped electron. Some of the principles of the method are described in more detail in the paper “Single Microwave Photon Detection with a Trapped Electron”, A Cridland et al, Photonics 3, 59 (2016). Put simply, the variation Δω_{z} of the frequency ω_{z} of the axial motion of the trapped electron is linked to the quantum number of the cyclotron motion of the trapped electron, under the Stern-Gerlach effect, as follows

$$Δ {ω}_{z} = {N}_{+} \cdot \frac{q ℏ {B}_{2}}{{m}^{2} {ω}_{Z}^{0}} \qquad ( 6 )$$

where q is the charge of the electron, B₂ is the curvature, or symmetric gradient, of the magnetic field, m is the mass of the electron and ω_{z}⁰ is the initial value of the frequency ω_{z} of the axial motion of the trapped electron. The spectrum analyser 122 is therefore arranged to detect changes in the frequency of the detection signal, and hence the frequency ω_{z} of the axial motion of the trapped electron. This allows the quantum number N₊ of the cyclotron motion to be analysed as follows.

If the target object 110 is not present, and hence the signal photon does not return to the ion trap 104, measurement of the axial and cyclotron quantum numbers produces

$${N}_{z , 0} = G ( {N}_{Z} ( 0 ) + {N}_{S} ) + ( G - 1 ) ( {N}_{B} + 1 ) \qquad ( 7 )$$

$${N}_{+ , 0} = G {N}_{B} + ( G - 1 ) ( {N}_{Z} ( 0 ) + {N}_{S} + 1 ) \qquad ( 8 )$$

On the other hand, if the target object 110 is present, and hence the signal photon is scattered back to the antenna 108 and returns to the ion trap 104 via the transmission line 106, measurement of the axial and cyclotron quantum numbers produces

$${N}_{z , 1} = G ( {N}_{Z} ( 0 ) + {N}_{S} ) + ( G - 1 ) ( 1 + {N}_{B} + κ ( {N}_{+} ( 0 ) + {N}_{S} ) ) + 2 \vert C \vert \sqrt{κ G ( G - 1 )} \qquad ( 9 )$$

$${N}_{+ , 1} = G {N}_{B} + ( G - 1 ) ( 1 + {N}_{Z} ( 0 ) + {N}_{S} ) + κ G ( {N}_{+} ( 0 ) + {N}_{s} ) + 2 \vert C \vert \sqrt{κ G ( G - 1 )} \qquad ( 10 )$$

Expressions for distinguishing between the presence and the absence of the target object 104 may then be given by

$$Δ {N}_{z} = {N}_{z , 1} - {N}_{z , 0} = κ ( G - 1 ) ( {N}_{+} ( 0 ) + {N}_{S} ) + 2 \vert C \vert \sqrt{κ G ( G - 1 )} \qquad ( 11 )$$

$$Δ {N}_{+} = {N}_{+ , 1} - {N}_{+ , 0} = κ G ( {N}_{+} ( 0 ) + {N}_{s} ) + 2 \vert C \vert \sqrt{κ G ( G - 1 )} \qquad ( 12 )$$

for the axial and cyclotron modes respectively, where
κ is reflectivity of the target object 110
G is the gain of the OPA.
N₊(0) is the initial average quantum number of the cyclotron motion N₊
N_{z}(0) is the initial average quantum number of the axial motion N_{z}
[symbol] is the strength of the quantum correlations created by entanglement
N_{S} is the number of entangled signal-idler quantum pairs created
N_{B} is the average quantum number of the thermal field.

Equations (11) and (12) represent the values which can be to discriminate between measurements in the presence and absence of the target object 110. The first term in each corresponds to the maximum classical discrimination that could be achieved from sending out an unentangled beam. The role of the correlations [symbol] , becomes clear: they contribute an additional term to the difference between the measured values in the presence and absence of the target object 110. Since κ<<1 and [symbol] ˜Nₛ, the measurement discrimination provided by QI is much greater than that available from a classical field, or

$$quantum illumination ≫ classical radar \qquad ( 13 )$$

However, it should again be noted that the detection can be based on either the quantum number N₊ of the cyclotron motion of the trapped electron (in accordance with equations (10) and (12) or the quantum number N_{z} of the axial motion of the trapped electron (in accordance with equations (9) and (11).

As used herein the term “quantum illumination” preferably connotes the use of phonons/vibrational modes of a trapped ion as idler or alternatively it may preferably connote the use of photons/electromagnetic modes as signal and idler.

An ion trap to perform quantum illumination (preferably using phonons/vibrational modes as idler), preferably comprises: a generation of a signal photon and an idler phonon/vibration mode; transmitting the signal photon; maintaining the idler; receiving a photon; and using the received photon and the idler to determine whether the received photon corresponds to the signal photon or to background.

Distinction between the reception of a signal photon and the reception of a photon from the background based on frequency changes may comprise: directing electromagnetic radiation to the trapped ion (for example an electron) from an electromagnetic source in order to cause the recombination of the vibrational modes of the ion trap; and use of a magnetic field for example in a “magnetic bottle” configuration.

Other variations and modifications will be apparent to the skilled person. Such variations and modifications may involve equivalent and other features which are already known and which may be used instead of, or in addition to, features described herein. Features that are described in the context of separate embodiments may be provided in combination in a single embodiment. Conversely, features which are described in the context of a single embodiment may also be provided separately or in any suitable sub-combination.

It should be noted that the term “comprising” does not exclude other elements or steps, the term “a” or “an” does not exclude a plurality, a single feature may fulfil the functions of several features recited in the claims and reference signs in the claims shall not be construed as limiting the scope of the claims. It should also be noted that the Figures are not necessarily to scale; emphasis instead generally being placed upon illustrating the principles of the present invention.

1. A quantum illumination apparatus comprising an ion trap.

2. The quantum illumination apparatus of claim 1, comprising a transmission line for conveying a signal photon to be directed to a target object and preferably wherein the ion trap is arranged to trap an ion selectively at either a first equilibrium position located a first distance from an input to the transmission line or at a second equilibrium position located at a second distance from an input to the transmission line.

3. The quantum illumination apparatus of claim 2, wherein the input to the transmission line is a cavity antenna.

4. The quantum illumination apparatus of claim 1, comprising a source of electromagnetic radiation coupled to the ion trap to provide photons of electromagnetic radiation generated by the source to the ion trap.

5. The quantum illumination apparatus of claim 4, where the source of electromagnetic radiation is arranged to provide electromagnetic radiation having a wavelength in the range 1 mm to 100 m.

6. The quantum illumination apparatus of claim 1, wherein the ion trap is arranged to trap an electron.

7. The quantum illumination apparatus of claim 1, wherein the quantum illumination apparatus is arranged to generate an ion for trapping in the ion trap, preferably wherein the quantum illumination apparatus comprises another source of electromagnetic radiation arranged to illuminate a target to release an ion for trapping in the ion trap, more preferably wherein the electromagnetic radiation is UV light and the ion is an electron.

8. The quantum illumination apparatus of claim 1, wherein a signal photon used for quantum illumination has a wavelength in the range 1 mm to 100 m.

9. The quantum illumination apparatus of claim 1, wherein the ion trap comprises a Penning trap, preferably a planar Penning trap.

10. The quantum illumination apparatus of claim 1, wherein the ion trap has an array of magnetic elements arranged to generate a magnetic field to trap an ion in the ion trap, which magnetic field is a magnetic bottle.

11. The quantum illumination apparatus of claim 1, wherein the ion trap has an array of electrodes arranged to generate an electric field to trap an ion in the ion trap, and a voltage source for controlling the electric potential applied to the array of electrodes such that a distance from the array of electrodes at which a/the ion trapped in the ion trap is held in the ion trap can be varied by varying the level of the electric potential applied to the array of electrodes by the voltage source.

12. The quantum illumination apparatus of claim 1, comprising a resonator selectively couplable to an electrode of an array of electrodes arranged to generate an/the electric field to trap an/the ion in the ion trap, the resonator being coupled to a signal detector for detecting electrical currents generated in the resonator by the trapped ion.

13. The quantum illumination apparatus of claim 1, comprising a cryogenic cooler for maintaining the ion trap at a temperature of less than around 40K in use, and preferably less than around 4.2K.

14. A method of quantum illumination using an ion trap.

15. The method of quantum illumination of claim 14, comprising the steps of:
trapping an ion in the ion trap;
directing electromagnetic radiation to the trapped ion to generate vibrational modes of motion of the trapped ion in two different degrees of freedom of motion of the trapped ion, which generated vibrational modes of motion are coupled to one another by quantum entanglement;
coupling the vibrational mode of motion of just one of the two different degrees of freedom of motion of the trapped ion to a transmission line so as to generate a signal photon;
maintaining the other of the two different degrees of freedom of motion of the trapped ion;
transmitting the signal photon to a target object;
receiving the signal photon from the target object;
coupling the received signal photon with the trapped electron; and
detecting changes in the frequency of the motion of the trapped electron in at least one of the vibrational modes of motion of the trapped electron in order to resolve reception of the signal photon from the background.

16. The method of quantum illumination of claim 15, wherein the trapped ion is an electron.

17. The method of quantum illumination of claim 15, wherein the electromagnetic radiation directed to the trapped ion to generate the vibrational modes of motion has a wavelength in the range 1 mm to 100 m.

18. The method of quantum illumination of claim 15, wherein coupling the vibrational mode of motion of just one of the two different degrees of freedom of motion of the trapped ion to transmission line comprises:
varying a voltage applied to at least one electrode of the ion trap to move the trapped ion closer to an input of the transmission line; and
controlling a switch to be in a conducting state such that a cavity in which the ion is trapped in the ion trap is electrically coupled to the transmission line.

19. The method of quantum illumination of claim 16, wherein detecting changes in the frequency of the motion of the trapped electron comprises detecting an AC voltage in a resonator coupled to at least one electrode of the ion trap.

20. The method of quantum illumination of claim 14, wherein a signal photon used for quantum illumination has a wavelength in the range 1 mm to 100 m.
